(19) United States
(12) Patent Application Publication
(10) Pub. No.: US 2009/0207469 A1
(43) Pub. Date: Aug. 20, 2009

(54) Method for reciprocal polarization (Cross-polarization)

(76) Inventors: Bernhard Rudolf Bausenwein, Hagelstadt (DE); Max Mayer, Forchheim (DE)

Correspondence Address: DR. BERNHARD RUDOLF BAUSENWEIN, EICHENSTR, 32, HAGELSTADT, D-93095, DE

(21) Appl. No.: 12/385,924

(22) Filed: Apr. 24, 2009

Related U.S. Application Data
(63) Continuation-in-part of application No. 10/587,850, filed on Jul. 28, 2006.

(51) Int. Cl. G02B 27/28; G02F 1/01

(52) U.S. Cl. 359/238; 359/487

(57) ABSTRACT

During cross-polarization, both sub-beams of a complex polarization undergo both a transmission and a reflection. To achieve this, a first polarizing sub-process is coupled to the complementary polarizing sub-process (transmission coupled to reflection, reflection coupled to transmission). Both sub-beams show the same polarization contrast and the same intensity, and both sub-beams are folded. The sub-beams are coupled by one common (transmission-reflection) process (a simple polarization). Cross-polarization is achieved alone by directing the beams and choosing appropriate polarizing vectors for the polarizers.

### CROSS-REFERENCE TO RELATED APPLICATIONS

Complex Polarizer System for Reciprocal Polarization (Cross-polarizer) U.S. Ser. No. 10/587,850

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

This is a continuation in part of patent application U.S. Ser. No. 10/587,850, published as US2005/0141076.

The present invention uncovers the method of cross-polarization, in which complementary polarizing processes are reciprocally coupled. The method relates especially to the design of complex polarizers, where not only the polarization contrast, but also the number of foldings of the beam has to be considered. It also relates to imaging devices involving polarized sub-beams.

### DISCUSSION OF THE STATE OF THE ART

In our application U.S. Ser. No. 10/587,850 we have uncovered the cross-polarizer, which couples complementary polarizations symmetrically and reciprocally. The cross-polarizer generates symmetric beam split or beam recombination. Moreover, complex cross-polarizers render possible very efficient architectures of systems employing two complementarily polarized light beams (e.g. 2-channel display systems with spatial light modulators). Before our application, in the state of the art (U.S. Pat. No. 5,921,650 Doany and Rosenbluth, U.S. Pat. No. 6,280,034 Brennesholz, WO03007074 Roth and Shmuel, EP1337117 Thomson SA) there were descriptions of arrangements of several polarizers for image engines with two LCoS imagers (FIG. 1A): all are similar in that a complex polarizer is used to feed the modulators and a second complex polarizer is used to superpose the modulated images. Both complex polarizers are characterized by the reflected sub-beam being led trough a second reflection, the transmitted beam being led through a second transmission.

Optionally, due to the asymmetric properties of simple polarizations, where the deflected sub-beam has a much lower polarization contrast than the transmitting sub-beam, the twice reflected sub-beams are coupled to a so-called cleanup polarizer. The transmitting sub-beam with its higher polarization contrast is not coupled to a cleanup system. In these realizations of complex polarizers, there are several asymmetries in the two sub-beams: the polarization contrast differs, and one channel undergoes two foldings, whereas the other channel sees none.

A different approach was used by WO 0063738/U.S. Pat. No. 6,490,087, Fulkerson et al. (FIG. 1B). Fulkerson et al. uncover a geometrically similar setup, but use additional halve-wave plates (λ/2). One plate is used to rotate the polarization of the beam transmitting the first PBS, a second is used to rotate the reflected beam. This has the consequence that the transmitted P-polarized beam, which has after the halve-wave-plate become a S-polarized beam, will reflect at the next PBS; while the reflected S-polarized beam, has become a P-polarized beam and will transmit the following PBS.

This setup is interesting, because both channels are symmetrically treated in the complex polarization process, both undergo exactly one reflection and one transmission and thus have the same polarization contrast, and both have gone through exactly one folding. The obvious disadvantage is that two halve-wave plates had to be introduced to achieve this. This is not only an additional load on the component side, but also introduces problems like wave-length dependencies and further optical matters.

In our application U.S. Ser. No. 10/587,850, we have focussed on a symmetric treatment of beams without the need of additional elements like cleanups or even halve-wave plates. Here, we uncover a method for a complex, reciprocal polarization with the minimum set of polarizations and no additional means but polarizations and beam guidance.

### DETAILED DESCRIPTION OF THE INVENTION

### 1. Working Principle of the Polarizers Used and Introduction of Designators.

Polarizing layers of the beam splitter type split an unpolarized light beam in two linearly polarized light beams (FIG. 2). In thin-film polarizers, which work according to Brewster's law, the angle of incidence is determined by the PBS. Moreover, the plane of incidence (POI, given by the axis of incident beam and plane of the polarizing layer) directly determines the plane of polarization (POP) of the transmitted and the reflected light: the transmitted light (“P”-polarized) has a POP parallel to POI (E2 in FIG. 2A), the reflected light (“S”-polarized) has a POP perpendicular to POI (E3 in FIG. 2A).

With the appearance of Cartesian polarizers, these strict relations were released, as neither the incidence angle is fixed by the plane of the polarizing layer nor is the POP of the transmitted (and reflected) beam determined by the POI, but by properties of the polarizing layer (e.g. obviously recognized in wire grid polarizers by the relative orientation of its wires). In our preceding application we have thus introduced the polarizing layer vector V as a new designator of polarizers. This vector is coplanar to the polarizing layer, and defined such that V (here V1) and the axis A1 (of the incident resp. transmitting beam) define the plane E1, which is perpendicular to the plane E2, which is the POP of the transmitting light. The axis A2 of the reflected beam and V1 determine the plane E3. This plane indicates the POP of the maximally reflected polarized light. FIG. 2B shows the relations in a wire grid polarizer, where V can easily by visualized to correspond to the orientation of the wires.

Accordingly, it is possible to specify V also in thin-film polarizers (V1 in FIG. 2A), which is always perpendicular to POI (in these polarizers, POP and POI are strictly coupled).

For a more stringent description of the cross-polarization method, it is helpful to introduce some further vectors besides V1. These are shown in FIG. 3. An incident light beam is characterized by its incidence vector 1, which specifies its direction. The incident beam may also be described by two further vectors P and Q. If the incident beam is linearly polarized, it has a POP which can be described by the POPs normal vector, which is P. The third vector Q is then the normal vector of a plane normal to the POP.

I, P and Q form a Cartesian coordinate system, where Q=P×I; (x cross product)

The beam is incident on a polarizing layer; the plane of the polarizing layer is described by its normal vector N. Whether the incident polarized beam is reflected or transmits the polarizer (polarizing transmission or polarizing reflection) is determined by the polarizing vector V. If we want to reflect the incoming polarized beam, V can be chosen such that V=Vref; if we want the incoming polarized beam to transmit, we choose V such that V=Vtrans.

Vref and Vtrans can be deduced from I, N and P resp. Q:

Vref=(N o Q)I−(N o I)Q; (I)

Vtrans=(N o P)I−(N o I)P; (II)

with (a o b) being the scalar product of a and b

The angle between Vtrans and Vref is given by cos(α)=Vtrans⁰ o Vref⁰, with Vtrans⁰, Vref⁰ being (normalized) unit vectors.

In the special case of POP being parallel to POI follows: Vtrans=P. If POP is perpendicular to POI follows: Vref=Q.

### 2. Cross-polarization: the Coupling of Polarizing Transmission and Polarizing Reflection Subprocesses

A central aspect of our invention is the coupling of a polarizing transmission to a polarizing reflection alone by beam guidance and the selection of the polarizing vector V for each of the sub-beams of a polarization process. This is indicated by FIGS. 4A and 4B. The polarizing transmission process along A1 at P1 can be coupled to a polarizing reflection process at P2 (FIG. 4A), if V2 is chosen such that P2 will maximally reflect the light with the POP maximally transmitting P1 with a vector V1. This is the case if V2 and the axis A1 of the incident beam form the plane E2, which is the POP of the incident light. Accordingly, a reflection process at P1 can be coupled to a polarizing transmission process at P2 (FIG. 4B), if V2 is chosen such that V2 and the axis A1 of the light incident on P2 form the plane E2 which is perpendicular to the POP of the incident light.

3. Cross-polarization: the Coupling of the Couplings. First Embodiment

In our invention of reciprocal polarization (cross-polarization) 4 polarization processes are coupled: a polarizing reflection and a polarizing transmission subprocess pr1, pt1 in a first beam B1 are coupled to a polarizing reflection and a polarizing transmission subprocess (pr2, pt2) in a second beam B2. We call this coupling of the two couplings reciprocal polarization, because transmission and reflection in both beams happen in opposite succession.

The couplings of the two sub-beams shown in FIGS. 4A,B are themselves coupled by a common simple polarization process. This is shown in FIGS. 5A, which shows the first embodiment of the invention. FIG. 5A shows that both beams B1 and B2 of the cross-polarization are reciprocally coupled; whereas B1 is led trough the subprocesses of transmission (pt1) and reflection (pr1), the beam B2 is also led through a transmission (pt2) and a reflection (pr2). Both beams are coupled in that the transmission process of one beam, and the reflection process of the other beam, are one common simple polarization process. In our first embodiment, this common process (pt1, pr2) takes place at a polarizing layer P1; the coupled processes pr1 and pt2 take place at different sites and at different polarizing layers, the vectors V of which may be different, as indicated by the different line types of the polarizing layers involved. The four polarization subprocesses take place at maximally 3 sites; 3 polarizing and normal vectors may be involved. No polarization rotating components are used but light guidance, which may involve optional means of folding in each beam path. The first embodiment is the general form of our process of cross-polarization.

4) The Method of Reciprocal Polarization does not Depend on the Number of Physical Polarizing Layers Involved: The Second Embodiment

While in FIG. 5A three layers P1, P2, P3 are involved in the method of cross-polarization, the same procedure can easily be achieved with two layers only. FIG. 5B shows a very similar setup to that shown in FIG. 5A, but has several restrictions: the subprocesses pr1 and pt2 occur at parallel layers (N(pr1)=N (pt2)) or even, as indicated by FIG. 5B, in the same geometric plane; in FIG. 5B, there is a further restriction used (Vref (pt2)=Vtrans (pr1)). As is shown in FIG. 5B, the four subprocesses may even be accomplished with only two physical polarizing layers. In the realization shown in FIG. 5B, there are no foldings between the two coupled subprocesses in either beam.

5) A Further Restriction of Reciprocal Polarization: all Four Subprocesses take Place at Two Locations. The 3rd Embodiment.

Not only can pt1 and pr2 be one common polarization, but cross-polarization can also be achieved if also pt2 and pr1 are chosen to be one common polarization. FIG. 6A shows again the restrictions of FIG. 5B, where pt2 and pr1 are carried out with identical N and V vectors. In FIG. 6B, these subprocesses are also carried out at the same place. This is achieved if the beams are folded to a common site, and the right choice of a N(pt2)=N(pr1) and Vtrans (pt2)=Vref (pr1).

Due to the common beam paths before and behind the cross-polarization process, this embodiment is useful especially if all independent processing of the polarized beams, e.g. modulations, are carried out on the separated beam paths between pt2/pr1 and pt1/pr2.

### 6) The Influence of Folding on the Polarization of a Beam

It is obvious from the description of a polarized beam, e.g. by the vectors introduced in FIG. 3, that reflecting a polarized beam has consequences for its polarization. FIGS. 7A,B show two conditions, where a linearly polarized beam is guided through a folding. In FIG. 7A the POP of the beam is parallel to the POI of the reflection, as indicated by the POPs normal vector Pi. In that case, the POP of the reflected beam (described by Pr) is unchanged (Pr=Pi). The vector Q, however, is transformed by the reflection, as is, obviously, the direction of the beam (Di, Dr).

In FIG. 7B again a linearly polarized beam is reflected. Here, the POP is perpendicular on the POI. In that case, the POP of the reflected beam (Pr) is transformed by the reflection (as is Di/Dr), while Qr=Qi.

Other angles between POP and POI are possible, their consequences are neither described quantitatively nor with respect to their polarization states here for the sake of simplicity, but can easily be deduced by those skilled in the art.

### 7) Complex Folding may Change the POP of a Beam

The combination of two reflections of a linearly polarized beam, including one reflection where POP is parallel POI and one reflection where POP is normal to POI has been used in the state of the art, e.g. in WO 2004 077102/U.S. Pat. No. 6,969,177 (Li and Inatsugu) for a polarization recovery system. As seen from above, an S-polarized beam (POP1) appears as P-Polarized beam (POP2) after passing this complex folding unit (CFU, FIG. 8).

The application of a CFU for each of the beams in cross-polarization results in the most extreme restriction shown in this application:

8. Cross-polarization with a Single V: the Fourth Embodiment

The fourth embodiment of the invention reduces all four subprocesses to occur with only one polarizing vector V, with the condition: V(pt1)=V(pr2)=V(pr1)=V(pt2). As FIG. 9B shows, we achieve this cross-polarizing method without actively polarization rotating components like wave plates or LCDs. Simple light guidance achieves all necessary transforms. In this minimum polarizer setup, a single polarizing layer might be used.

### BRIEF DESCRIPTION OF THE SEVERAL VIEWS OF THE DRAWING

FIGS. 1A,B schematically show complex polarizer arrangements of the state of the art.

FIGS. 2A,B schematically shows the principle of polarizing beam splitters.

FIG. 3 shows functional characteristics of polarization vectors.

FIGS. 4A,B schematically show couplings of polarizing transmission and polarizing reflection.

FIGS. 5A,B schematically show a first and second embodiment of cross-polarization.

FIGS. 6A,B schematically show a third embodiment of cross-polarization.

FIGS. 7A,B schematically show foldings of a linearly polarized beam.

FIG. 8 schematically shows a complex folding unit.

FIGS. 9A,B schematically show a fourth embodiment of cross-polarization.

### DETAILED DESCRIPTION OF THE FIGURES

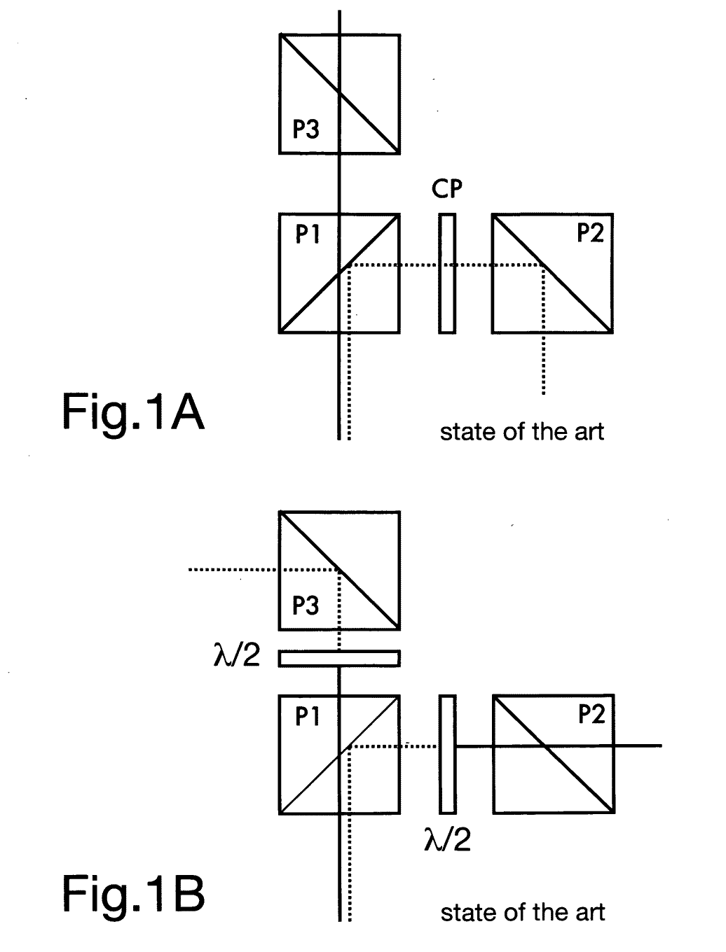

FIG. 1 shows two complex polarizers according to the state of the art. FIG. 1A shows the coupling of two reflecting processes (at P1, P2, dotted line) and the coupling of two transmitting processes (P1, P3, continuous line). Due to the relative poor polarization contrast achieved in the reflection pathway, an optional cleanup polarizer is useful here. FIG. 1B shows also an arrangement of 3 polarizing beam splitters, but uses two further components: halve-wave plates (λ/2) between P1 and P2 and between P1 and P3. The P-polarized beam gets transformed to an “S”-polarized beam by the λ/2 plate between P1 and P3; this beam, transmitted through P1 is now reflected at P3 after the polarization rotation. The S-polarized, reflected beam (dotted line at P1) is transformed to a P-polarized beam by the λ/2 plate between P1 and P2. this beam, reflected at P1 is then transmitting P2 after the polarization rotation.

In both techniques, all PBS used are arranged with a POI in the drawing plane, and all of them reflect S-polarized light and transmit P-polarized light.

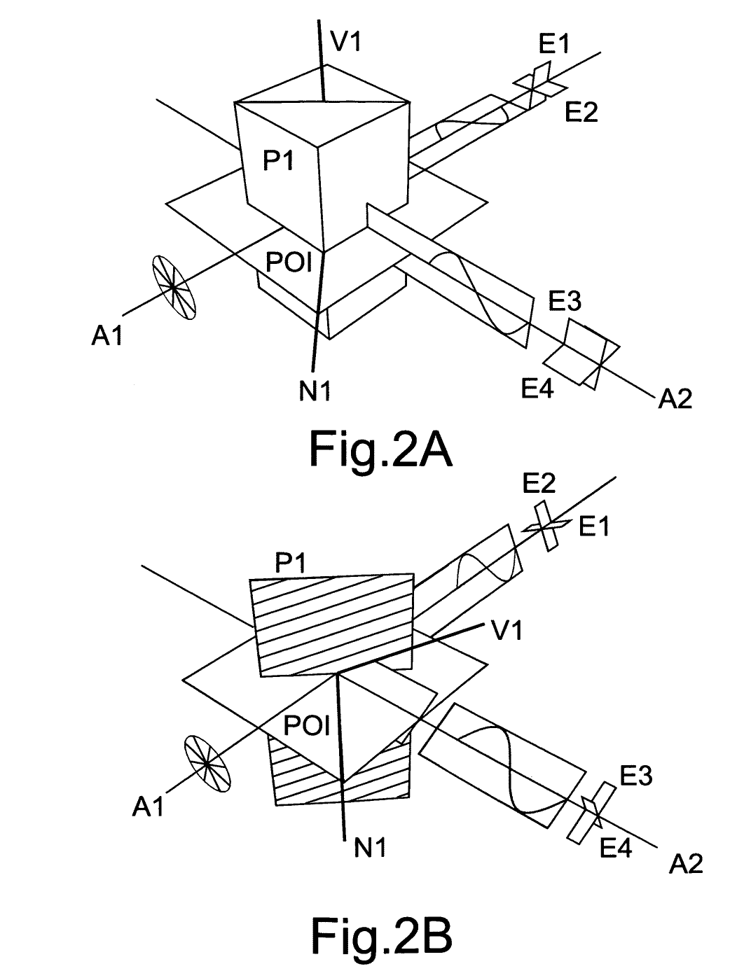

FIG. 2 shows the working principle of polarizing beam splitters and a definition of polarizing layer vector V and normal vector N. Thin-film polarizers (e.g. MacNeille-PBS, P1 in FIG. 2A) split an unpolarized beam into tow linearly polarized sub-beams. The planes of polarization E2 and E3 are coupled in such a way to the plane of incidence (POI) that the sub-beam derived from a polarizing transmission along the optical axis A1 has a POP parallel to POI (“P”-polarization) and the sub-beam created by a polarizing reflection along the optical axis A2 has a POP perpendicular to the POI. A1 is perpendicular to A2 and each axis has an angle of 45 degree with the normal vector N1 (Brewster principle). The polarizing layer vector V1, perpendicular to POI, and A2 define the POP E3 of the reflected sub-beam; the polarizing layer vector V1 and A1 define a plane E1 perpendicular to the POP E2 of the transmitted sub-beam. Using cartesian polarizers (e.g. wire grid polarizers WGP, P1 in FIG. 2B), V1 does not depend on POI (accordingly, in polarizers using Brewster's principle V1 is always perpendicular to the POI). V1 corresponds to the WGP grid structure and together with A2 defines the POP E3 of the reflected sub-beam; V1 and A1 define a plane E1 perpendicular to the POP E2 of the transmitted sub-beam. Each POP of the two sub-beams can have (in contrast to Brewster polarizers) an angle with POI different from 0 or 90 deg.

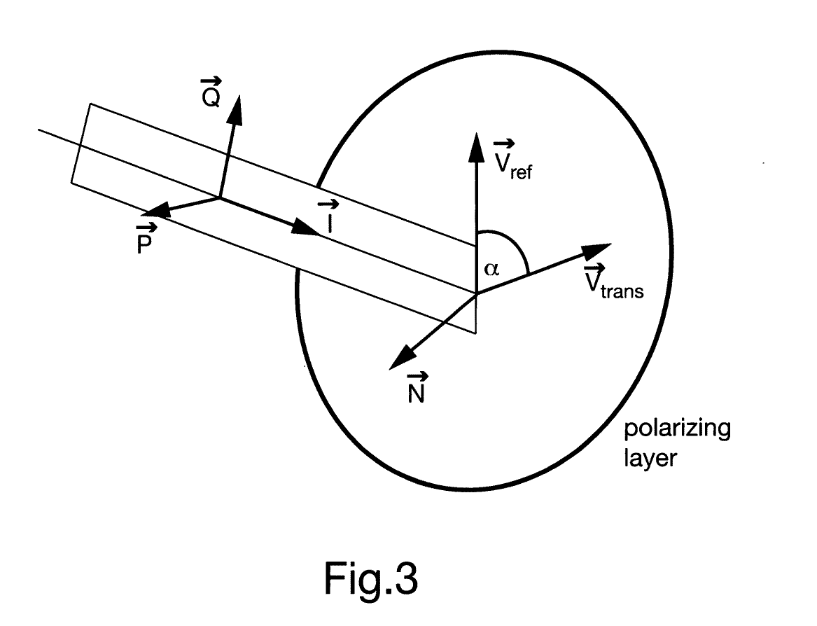

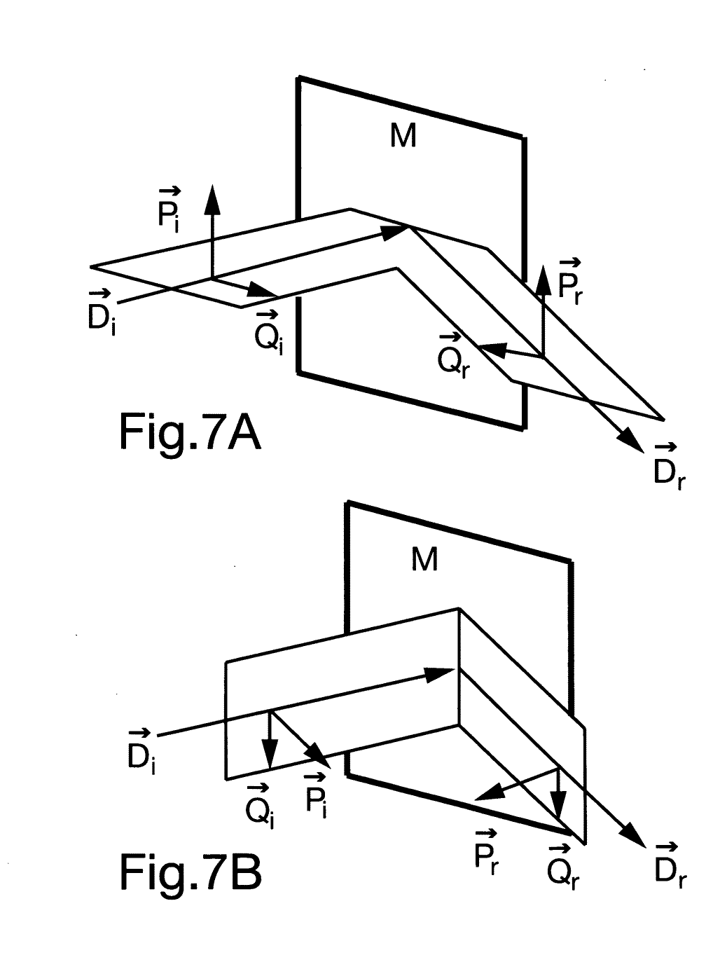

FIG. 3 shows the major vectors involved in the polarization process. A linearly polarized incident beam is characterized by its incidence vector 1. Its plane of polarization (POP) is described by the POPs normal vector P. The vector Q is the normal vector of a plane normal to the POP. The beam is incident on a polarizing layer which is indicated by a circle; the plane of the polarizing layer is described by its normal vector N. Whether the incident polarized beam is reflected or transmits the polarizer (polarizing transmission or polarizing reflection) is determined by the polarizing vector V which is coplanar with the plane of the polarizing layer: V_{ref} is the vector-which results with the maximum reflection of the incident polarized beam. Vₜᵣₐₙₛ is the polarizing vector which results with the maximum transmission of the incident polarized beam. The angle between V_{ref} and Vₜᵣₐₙₛ is designated by α. For Ir, Pr, and Qr vectors of the reflected beam compare FIG. 7.

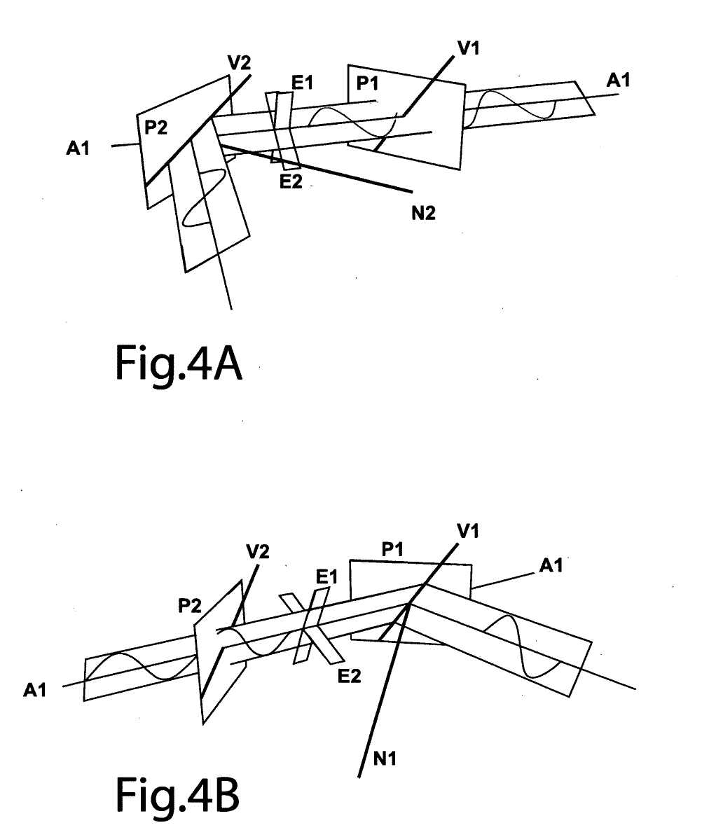

FIG. 4 shows one basic principle of cross-polarization: the reciprocal coupling of a polarizing transmission with a polarizing reflection. FIG. 4A shows how a linearly polarized beam, transmitting P1 is coupled to a polarizing reflection subprocess at P2, alone by beam guidance and selecting the right V2 of P2. V2 together with the axis A1 of the P1 transmitting beam spans the plane E2. This plane E2 describes the POP of the beam transmitting P1 (indicated by the sinusoidal curve in E2). E2 is perpendicular to the plane E1 spanned by V1 (of P1) and A1.

FIG. 4B shows the complementary coupling: a linearly polarized beam, being reflected at P1 is coupled to a transmitting subprocess at P2, alone by beam guidance and selecting the right V2 of P2. V2 together with the axis A1 spans the plane E2. This plane E2 now describes a plane perpendicular to the POP of the beam reflected at P1 (indicated by the sinusoidal curve). The POP of the beam reflected at P1 is now described by the plane E1, which is spanned by V1 (of P1) and A1.

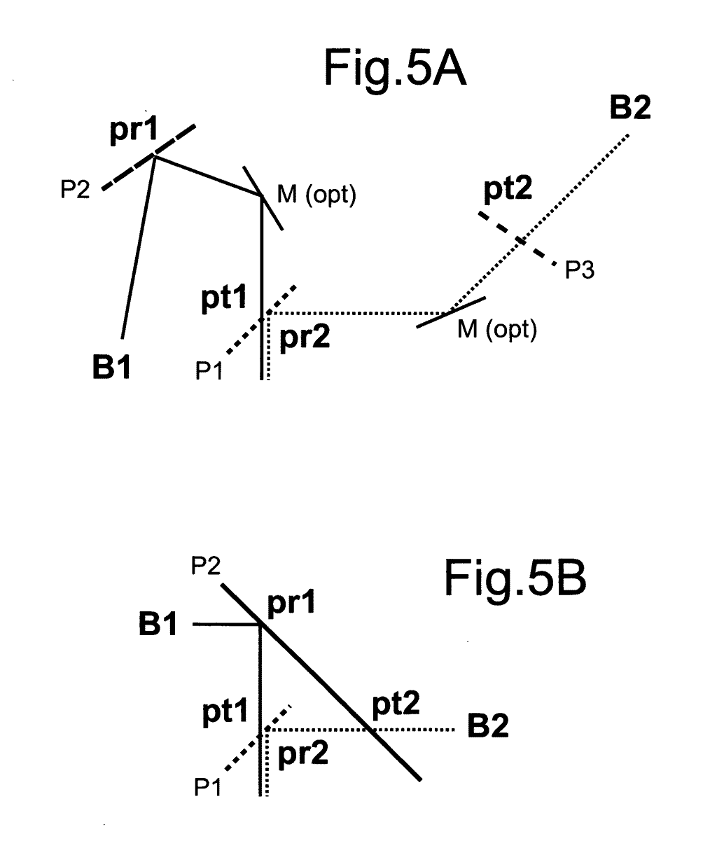

FIG. 5A shows the a general embodiment of cross-polarization The two couplings of a polarizing transmission and a polarizing reflection are themselves coupled by a common polarization process. Here, pt1 (the polarizing transmission of the beam B1) and pr2 (the polarizing reflection of the beam B2) are one common simple polarization process at the polarizer P1. Both beams B1 and B2 have the same polarization processes: B1 undergoes a transmission (pt1) at polarizing layer P1 and a reflection (pr1) at a polarizing layer P2, B2 undergoes a reflection (pr2) at P1 and a transmission (pt2) at P3. The beam guidance between these coupled reciprocal processes may involve optional means for folding (M opt) for B1 and B2.

FIG. 5B shows the second embodiment. It is a rather special, greatly restricted version of the method shown in FIG. 5A. First, there are no foldings between the coupled processes. Secondly, the polarizers P2 and P3 have been combined to a common polarizer P2, which does not only put geometric restrictions (same layer) on the polarizers but also reduces the choices of the (only two) Vs in the system dramatically.

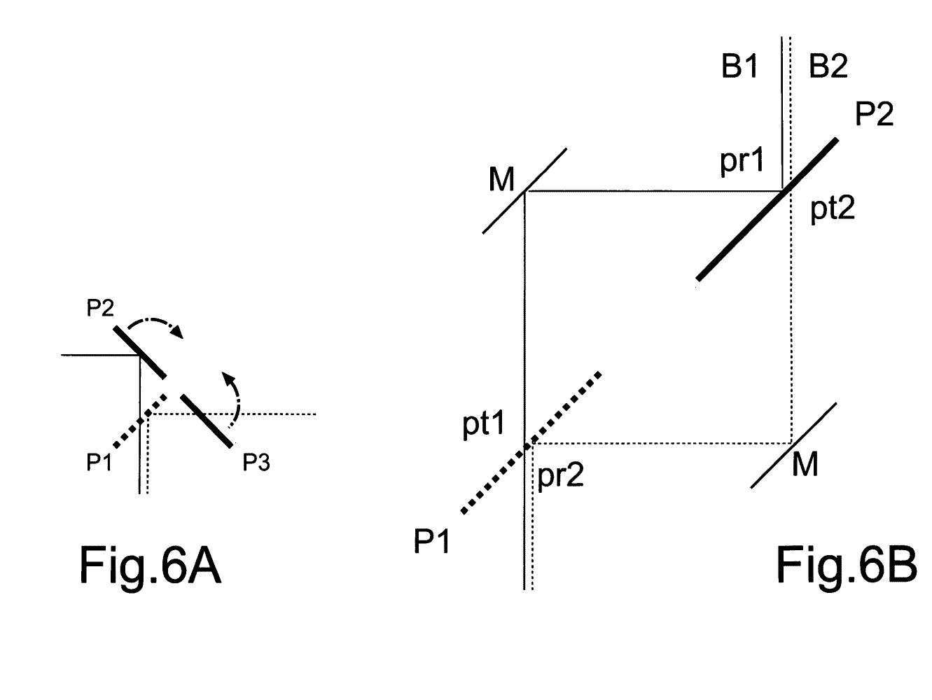

FIG. 6 shows the third embodiment. It provides a further restriction to the embodiment shown in FIG. 5B. When the beams are folded, pr1 and pt2 can be chosen to be, like pt1 and pr2, one common process carried out at one same layer (P2). FIG. 6A shows how this method is deduced from the method shown in 5B, with P2/P3 being folded to be parallel, and finally being melt to one common polarizing layer. Due to the couplings in two common polarization processes, both linear polarized sub-beams B1 and B2 are separated only between the subprocesses.

FIGS. 7A,B show the influence of foldings on the polarization of a reflecting beam for two special conditions. FIGS. 7A,B both show a linearly polarized incident beam, with its direction vector (Di) and its plane of polarization POP being described by its normal vector Pi and the vector Qi, which is the normal vector of a plane normal to the POP, and the reflected beam with its direction vector (Dr), its plane of polarization (Pr) and the reflected vector Qr. In FIG. 7A, the plane of incidence (POI, spanned by Di and Dr) is parallel to the POP of the incident beam. The reflection in this case leads to Pr=Pi, the POP being unchanged by the reflection. FIG. 7B shows the same situation with the POP of the incident beam being perpendicular to the POI. In this case, the POP is transformed by the reflection, whereas Q remains unchanged.

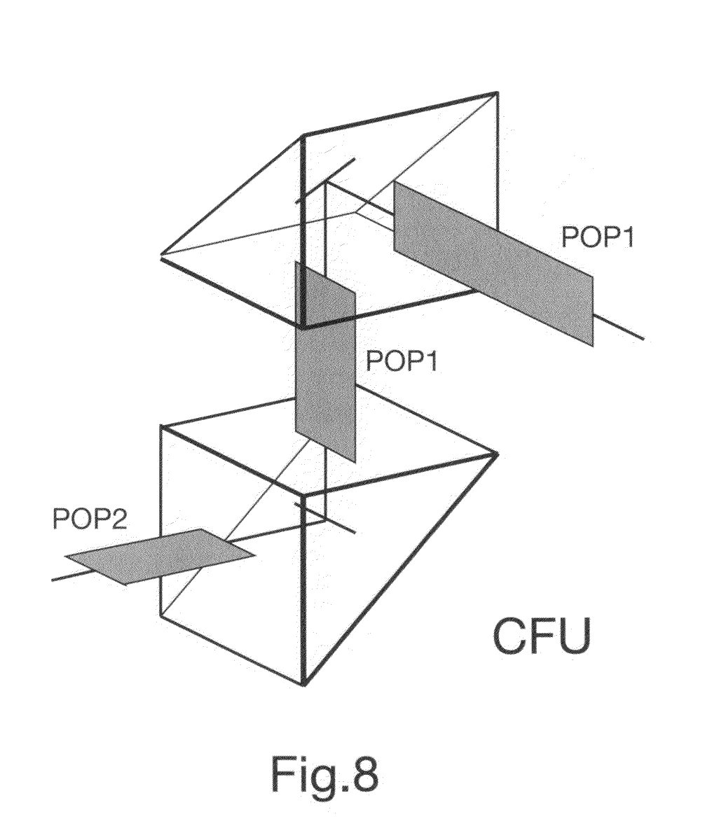

FIG. 8 shows a folding unit composed of the two special situations in FIG. 7. We call these foldings, which consist of more than one folding, as “complex folding units” (CFU). Similar CFUs have been described in the state of the art (see text). FIG. 8 shows that a CFU can be used to rotate the POP of a linear polarized beam alone by beam guidance without active or passive polarization rotating components. In FIG. 8 we show a CFU consisting of two total internal reflection (TIR)-prisms. After being guided through the CFU, a linearly polarized beam has a rotated POP (compare POP1 and POP2). This can even be achieved without a chance of the direction of the beam: just imagine a further folding by a third TIR to give the beam its original direction without changing its polarization (not shown).

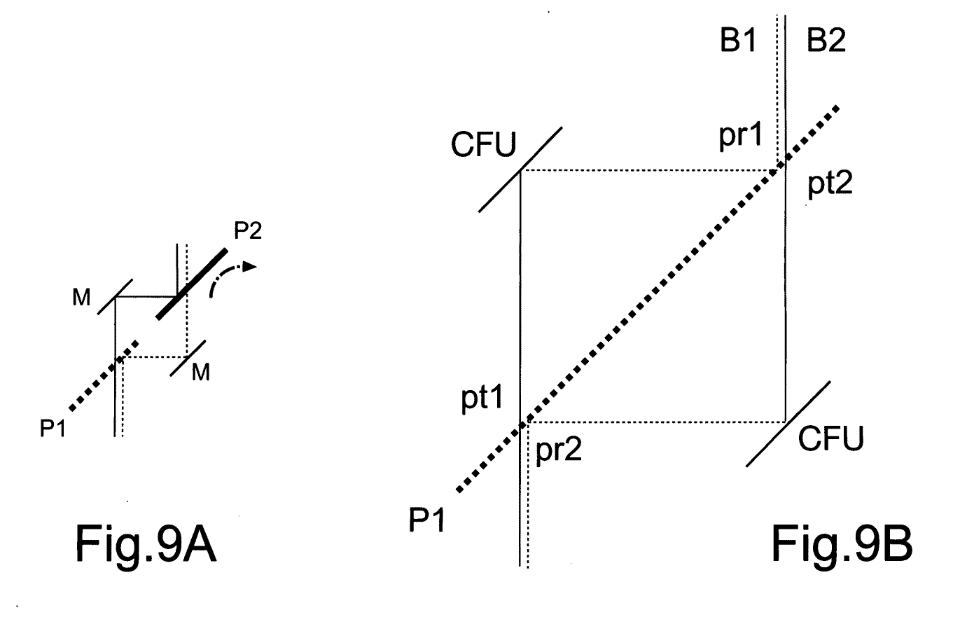

FIG. 9B shows a further, strongly restricted realization of the cross-polarization method using two CFUs as introduced in FIG. 8. In a schematic diagram, as seen from above (FIG. 9B) the beams B1, B2 passing the CFUs change their POPs (indicated by the switch from dotted lines to a continuous line, and vice versa for the second beam). This allows us to use only one polarizing layer vector V for all four subprocesses involved in cross-polarization. FIG. 9A indicates how this realization can be understood to be evolved from the realization shown in FIG. 6B. If one imagines the polarizers in FIG. 6B to be vertical (pt1, pr2) and horizontal (pt2, pr1) wire grid polarizers, it is possible to rotate P2 about its normal vector (not shown) until it has the same V as P1.

It will be appreciated that whilst this invention is described by way of detailed embodiments, these realizations serve as illustrations of the invention but not as a limitation of the invention; numerous variations in form and detail can be deduced by those skilled in the art or science to which this invention pertains without leaving the scope of the invention as defined by the following claims:

1. Method for reciprocal polarization (cross-polarization),
using a light source;
using two beams B1 and B2;
using four polarization beam splitting subprocesses (two polarizing transmissions pt1, pt2 and two polarizing reflections pr1, pr2) characterized by their polarization vectors;
coupling B1 to pt1 and pr1 by guiding B1 and choosing the polarizing vectors of said pt1 and pr1;
coupling B2 to pt2 and pr2 by guiding B2 and choosing the polarizing vectors of said pt2 and pr2;
coupling said beams B1 and B2 such that pt1 and pr2 are a common polarization process.

2. Method for reciprocal polarization (cross-polarization) according to claim 1, pt2 and pr1 occurring at different sites.

3. Method for reciprocal polarization (cross-polarization) according to claim 2, B1 passing pt1 before pr1.

4. Method for reciprocal polarization (cross-polarization) according to claim 2, B2 passing pt2 before pr2.

5. Method for reciprocal polarization (cross-polarization) according to claim 1, additionally using means for folding in either of said beams B1 and B2.

6. Method for reciprocal polarization (cross-polarization) according to claim 1, coupling said beams B1 and B2 such that pt2 and pr1 are also a common polarization process.

7. Method for reciprocal polarization (cross-polarization) according to claim 6, said means for folding involving reflective microelectromechanical systems (MEMSs).

8. Method for reciprocal polarization (cross-polarization) according to claim 5, said means for folding being complex folding units (CFU), said CFUs consisting of at least two reflections.

9. Method for reciprocal polarization (cross-polarization) according to claim 6, additionally using two spatial light modulators (SLMs), B1 being modulated by one of said SLMs between said processes pt1 and pr1, and B2 being modulated by said second SLM between said processes pt2 and pr2.

10. Method for reciprocal polarization (cross-polarization) according to claim 1, additionally using spatial light modulators (SLMs), B1 and B2 being used to feed said SLMs.

11. Method for reciprocal polarization (cross-polarization) according to claim 1, additionally using spatial light modulators (SLMs), B1 and B2 being used to superpose the modulated images of said SLMs.

12. Method for reciprocal polarization (cross-polarization) including the method according to claim 10 and including the method according to claim 11.

13. Method for reciprocal polarization (cross-polarization) according to claim 12, said SLMs being reflective and modulating the image by the rotation of the polarization.
